(19) United States
(12) Patent Application Publication
(10) Pub. No.: US 2003/0035977 A1
(43) Pub. Date: Feb. 20, 2003

(54) Barrier layer for electrical connectors and methods of applying the layer

(76) Inventor: Amit Datta, East Greenwich, RI (US)

Correspondence Address: DREIER & BARITZ LLP, 499 PARK AVENUE, 20TH FLOOR, NEW YORK, NY, 10022, US

(21) Appl. No.: 10/015,500

(22) Filed: Dec. 11, 2001

Related U.S. Application Data
(60) Provisional application No. 60/254,751, filed on Dec. 11, 2000.

(51) Int. Cl. C25D 7/00; C25D 3/56; C25D 3/00; B32B 15/20

(52) U.S. Cl. 428/675; 205/50; 205/255; 205/257; 205/261; 428/648; 428/929

(57) ABSTRACT

A metal contact for a copper alloy surface, comprising: electroplated barrier layer having a thickness ranging from about 0.00001 inch to about 0.0001 inch, wherein the barrier layer is selected from the group consisting of cobalt, cobalt-nickel alloys, cobalt-tungsten alloys, cobalt-nickel-tungsten alloys, and rhodium

### CROSS-REFERENCE TO RELATED APPLICATIONS

This application claims the benefit under 35 U.S.C. 119(e) of U.S. Provisional Application Ser. No. 60/254,751, filed Dec. 11, 2000.

### BACKGROUND

Electrical contacts are generally made from copper or copper alloys due to their relatively high electrical conductivity. However, copper alloys oxidize easily, which reduces the integrity of the electrical contacts. Therefore, copper electrical contacts are generally coated with a layer of material that oxidizes less readily than copper. One example of such a material is tin, which is typically applied as a coating ranging in thickness from about 0.0001 to about 0.0003 inch. In addition to preventing the copper contacts from oxidizing and thereby maintaining the electrical integrity of the contacts, the tin coating also imparts solderability if needed for the application.

One problem associated with using tin coating is due to the relatively high rate of diffusibility of copper in tin (0.8×10⁻⁶ cm²/sec @ 500K). Copper also forms solid solutions with tin, and may also form stable intermetallics such as Cu₃Sn and Cu₆Sn₅, which severely degrade contact resistance, leading to failure of soldered joints or contacts.

To minimize or eliminate the interaction of the copper with the tin, an intermediate, or barrier layer is sometimes applied between the copper layer and the tin layer. Examples of such barrier layers include nickel, palladium-cobalt, and gold. Palladium-cobalt and gold barrier layers are effective but expensive and their use is generally limited to critical connectors for computer applications. Nickel layers are less expensive and are therefore used in high-volume price sensitive applications, such as automotive electronics applications. Ever increasing use of automotive electronics under the hood, which are generally exposed to temperatures of greater than about 100° C., have created the need for an alternate barrier layer with superior performance and reduced cost.

Attempts to provide alternative barrier layers include the electroplating of nickel over a nickel-phosphorus layer, as shown in FIG. 1; the use of cobalt-tungsten phosphide has also been reported as a barrier material; and use of a thicker tin layer has also been tried as a way to maintain the electrical integrity of the contacts.

However, thicker tin layers tend to gall, thereby increasing the contact insertion force. “Gall,” or “galling” as used herein, means plastic deformation at the interface of two surfaces resulting from the two surfaces sliding against each other, retarding further movement. In electrical contact applications, soft tin coated connectors tend to gall when inserted in tin coated female adaptors, thereby increasing the insertion force.

### SUMMARY

In one embodiment, the present invention is directed to a metal contact for a copper alloy surface. The metal contact includes an electroplated barrier layer having a thickness of about 0.000025 inch to about 0.0001 inch. The barrier layer is selected from the group consisting of cobalt, cobalt alloys, nickel-cobalt-tungsten, and rhodium.

In another embodiment, the present invention is directed to a method of forming a metal contact having a contact resistance of less than about 10 milliohms. The method involved the steps of providing a copper substrate and electroplating a barrier layer on the substrate. The barrier layer is selected from the group consisting of cobalt, tungsten, tungsten alloys, and rhodium.

In another embodiment, the present invention is directed to an electrical contact. The electrical contact includes a copper substrate and a barrier layer selected from the group consisting of cobalt, tungsten, tungsten alloys, and rhodium. The electrical contact has a contact resistance of less than about 10 milliohms.

### BRIEF DESCRIPTION OF THE DRAWINGS

It should be understood that the drawings are provided for the purpose of illustration only and are not intended to define the limits of the invention. The foregoing and other objects and advantages of the embodiments described herein will become apparent with reference to the following detailed description when taken in conjunction with the accompanying drawings in which:

FIG. 1 is a schematic illustration of a prior art metallization scheme; and

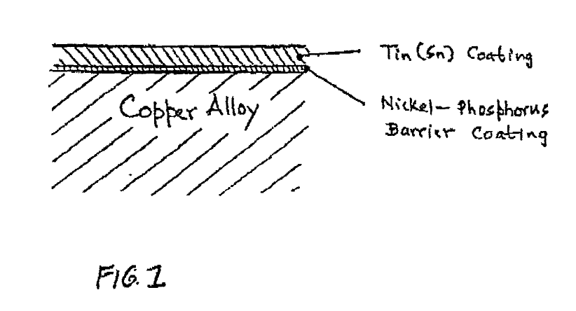

FIG. 2 is a schematic illustration of one embodiment of the metallization scheme with a nickel, cobalt, tungsten and rhodium barrier layer.

### DETAILED DESCRIPTION OF THE INVENTION

The present invention is directed to an improved barrier layer for electrical contacts, more specifically for electrical contacts formed using relatively low resistance substrate materials.

The improved barrier layer maintains the integrity of the contact resistance. As such, the barrier layer of the present invention preserves the low contact resistance of the substrate material by minimizing interactions between the substrate material, the barrier layer and, in another embodiment, the finish coating which include, but are not limited to, Sn and precious metals such as Au. In one embodiment, the improved barrier layer of the present invention has a resistivity somewhat higher than the substrate material, relatively low diffusivity in the substrate material, relatively low solid solubility in the substrate material, and relatively high intrinsic electrical conductivity. In addition to maintaining the integrity of the electrical contact and preventing degradation of the contact resistance, the barrier layer should also have a low friction coefficient.

In another embodiment, the improved barrier layer may be electroplated on the substrate at relatively high speed and with relatively high efficiency. In a further embodiment, in addition, the barrier layer is composed of materials that are precious metal-free and relatively low cost. In yet another embodiment, the barrier layer adheres well to tin or gold, is relatively hard, and is anti-galling for low insertion force. “Anti-galling,” as used herein, means preventing or reducing plastic deformation at the interface when two surfaces are sliding against each other, retarding further movement. “Anti-galling,” as used herein with reference to electrical contact applications, means reducing the insertion force of coated connectors into soft tin coated female adaptors.

Materials that have been found suitable for the barrier layer of the present invention include rhodium cobalt and cobalt alloys such as cobalt-tungsten, cobalt-nickel-tungsten and nickel-tungsten. Although, copper also has a relatively low diffusivity in tungsten, tungsten cannot be electroplated as elemental tungsten. It can be plated as a tungsten alloy such as Co—W, Ni—W or Co—Ni—W, with a relatively high efficiency.

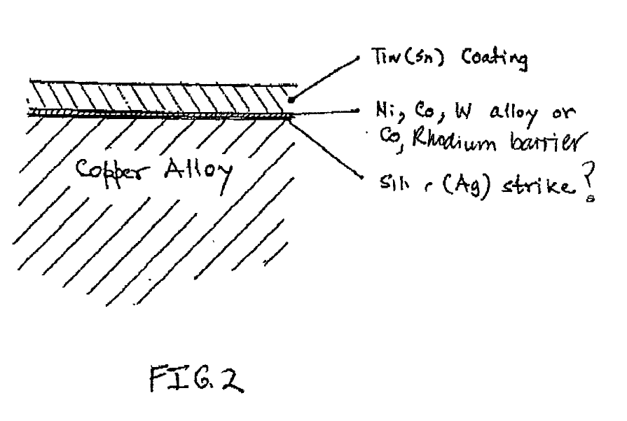

One embodiment of an electrical contact 10 is illustrated schematically in cross-section in FIG. 2. As shown in FIG. 2, electrical contact 10 includes a substrate 12, a strike layer 14, and a barrier layer 16. Although not necessary, in some embodiments an outer layer 18 may be included. In one embodiment, substrate 12 may be any low resistance material. In a preferred embodiment, substrate 12 is copper. As used herein, “copper” refers to copper and alloys of copper.

In one embodiment, electrical contact 10 has a resistance of less than about 10 milliohms, more preferably less than about 5 milliohms, and in a particularly preferred embodiment, less than about 2 milliohms.

Strike layer 14 may be formed from a metal material including, but not limited to, gold, silver, platinum, palladium, and combinations thereof. The purpose of strike layers, which are known in the art, is to among other things provide a suitable surface on which to apply a successive layer, which is in the present embodiment the barrier layer 16. In an embodiment, strike layer 14 is very thin, particularly having a thickness ranging from about 5 microinch to about 20 microinch, more particularly about 10 microinch.

The barrier layer 16 of the present invention can be any of the afore-mentioned barrier materials. In one embodiment, barrier layer 16 is composed of a barrier material of cobalt or an alloy of tungsten such as nickel-cobalt-tungsten. In a further embodiment, barrier layer 16 may have a thickness ranging from about 0.00001 inch to about 0.0001 inch, more particularly about 0.00005 inch.

In a further embodiment, the electrical contact may include an outer layer 18. In one embodiment, outer layer 18 is composed of a material having a relatively low oxidation tendency and that is usually solderable. For example, suitable materials for outer layer 18 include, but are not limited to, tin or precious metals such as gold, silver, platinum, palladium and combination thereof.

In one embodiment of the present invention for forming the electrical contact, a suitable substrate is utilized such as copper or a copper alloy. In one specific embodiment, the substrate is subjected to a first surface treatment to remove any surface oxidation and, if desired, a second surface treatment to activate the surface in preparation for electroplating the barrier layer. The surface activation may be, for example, depositing a strike layer, which is known in the art. Suitable strike layers may include, for example, nickel or silver.

In a further embodiment, after the surface treatment(s) is applied, the substrate may be immersed in an electroplating bath in order to deposit the barrier layer of the present invention on the substrate or on the strike layer. In yet another embodiment, after depositing the barrier layer, if desired, an outer layer may be deposited, for example by electroplating, although other methods known to those of skill in the art may be used, including evaporation, sputtering, and resistance evaporation. In yet a further embodiment, tin may be deposited as the outer layer.

Suitable plating baths for the barrier layer include cobalt sulphamate solutions, sodium tungstate solutions, cobalt and nickel sulphamate and sodium tungstate solutions, and nickel sulphate and sodium tungstate solutions. The electroplating baths may additionally include additives, brighteners, anti-pitting additives, and the like. If desired or necessary, the pH of the electroplating bath may be adjusted and/or buffered as known to those of skill in the art.

The present invention will be further illustrated by the following examples, which are intended to be illustrative in nature and are not to be considered as limiting the scope of the invention.

### WORKING EXAMPLES 1 AND 2

Metal contacts using a variety of different barrier layers were formed in order to evaluate their contact resistivity. The barrier layers were electroplated at relatively high speed and relatively high efficiency. “High speed,” as used herein, means about 25 microinch/minute. “High efficiency,” as used herein, means greater than about 50% efficiency. Each barrier layer was applied to a copper substrate. The surface of each copper substrate was treated by lightly etching the substrate in a standard acid bath for about 20 seconds to remove any surface oxide layers and to “activate” the surface. In some instances, the effects of surface activation were also examined using a 2 minute nickel strike (Wood's) or a 20 second standard silver strike (silver cyanide).

Current densities were varied to get a bright deposit. Current densities, pH, and temperature were adjusted to achieve a bright finish. Plating times were selected according to metal concentrations and current densities to achieve a coating thickness of less than or equal to about 0.0002 inch, more preferably about 0.0001 inch.

Samples were examined in the as-received, as-aged, as tin-plated and as tin-plated and aged condition. Aging was performed for 240 hours at 150° C.

Samples were tested to determine the contact resistance at various loads in the as-received, as tin-plated and aged condition (3000 hours at 125° C.). Contact resistance values greater than about 10 milliohms were considered failures. The codes listed in Table 1 below were used to represent the contact resistance values of the samples.

TABLE 1

| CONTACT RESISTANCE | CODE |
|---|---|
| greater than about 10 milliohms | Fail (F) |
| about 5 to about 10 milliohms | Good (G) |
| about 2 to about 5 milliohms | Very Good (VG) |
| less than about 2 milliohms | Excellent (E) |

### EXAMPLE 1

### COBALT

A layer of cobalt was electroplated on a copper substrate for evaluation as a barrier layer. The cobalt was deposited using a bath containing cobalt sulphamate, and citric acid. The pH of the plating bath was adjusted to a range of about 3-5 using cobalt carbonate.

TABLE 2

| Sample | I | II | III | IV |
|---|---|---|---|---|
| Acid Etch | yes | yes | yes | yes |
| Strike | no | nickel | no | silver |
| Anode | Nickel or | Nickel or | Nickel or | Nickel or |
| | Cobalt | Cobalt | Cobalt | Cobalt |
| Cathode | | | | |
| Plating Bath | cobalt | cobalt | cobalt | cobalt |
| Composition | sulphamate | sulphamate | sulphamate | sulphamate |
| Plating Bath | none | none | none | none |
| Additives | | | | |
| Plating Bath | 140 | 140 | 140 | 140 |
| Temperature | | | | |
| (° F.) | | | | |
| Current | 40 | 40 | 40 | 40 |
| Density (ASF) | | | | |
| Time (minutes) | 2-3 | 2-3 | 2-3 | 2-3 |
| pH range | 3-5 | 3-5 | 3-5 | 3-5 |
| pH adjustment | cobalt | cobalt | cobalt | cobalt |
| | carbonate | carbonate | carbonate | carbonate |
| Plating Deposit | cobalt | cobalt | cobalt | cobalt |

TABLE 3

| | | | | AS TIN- |
|---|---|---|---|---|
| | AS- | | | PLATED |
| SAMPLE | RECEIVED | AS TIN-PLATED | AS-AGED | AND AGED |
| I | E | — | E | — |
| II | G | — | F | — |
| III | — | G | — | G |
| IV | — | G | — | VG |

As shown in Table 3, cobalt sulphamate without any additives produces an excellent barrier coating and may not require any tin coating (or an extremely thin tin coating). A light etch without any subsequent nickel strike produces an acceptable surface activation of copper alloys. Moreover, the resulting contact resistance is superior to surface treatment that includes a light etch and nickel strike. However, surface treatment that includes a light etch followed by a silver strike produces a superior contact resistance value.

### EXAMPLE 2

### NICKEL-TUNGSTEN

A layer of nickel-tungsten was electroplated on a copper substrate for evaluation as a barrier layer. The nickel-tungsten coating (65% Ni, 35% W) was deposited using a bath (Enthone Ni-500) containing nickel sulphate, sodium tungstate, and citric acid. Enthone Ni-500 plating bath contains a nickel salt (such as nickel sulphate), a tungsten salt (sodium tungstate), and an organic acid (citric acid).

The pH of the plating bath was adjusted to a range of about 7-9 using ammonium hydroxide.

TABLE 4

| Example | V | VI | VII |
|---|---|---|---|
| Acid Etch | yes | yes | yes |
| Strike | no | nickel | silver |
| Anode | inert or soluble | inert or soluble | inert or soluble |
| | W | W | W |
| Cathode | | | |
| Plating Bath Additives | | | |
| Nominal Plating Bath | 140 | 140 | 140 |
| Temperature (° F.) | | | |
| Current Density | 20-50 | 20-50 | 20-50 |
| (ASF) | | | |
| Time (minutes) | 5 | 5 | 5 |
| pH range | 7-9 | 7-9 | 7-9 |
| pH adjustment | ammonia | ammonia | ammonia |
| Plating Deposit | nickel tungsten | nickel tungsten | nickel tungsten |

TABLE 5

| | AS- | AS | | AS TIN-PLATED |
|---|---|---|---|---|
| SAMPLE | RECEIVED | TIN-PLATED | AS-AGED | AND AGED |
| V | E | G | F | VG |
| VI | F | — | F | — |
| VII | E | VG-E | F | VG-E |

As shown in Table 5 above, a nickel-tungsten alloy coating electroplated from an alkaline bath containing a nickel salt (such as nickel sulphate), a tungsten salt (sodium tungstate), an organic acid (citric acid) and ammonium hydroxide can produce an excellent barrier coating. A light acid etch is an acceptable surface treatment. Contact resistance values can be improved with a silver strike following the light etch. The Ni—W coating requires, however, a tin outer layer to retain its excellent contact resistance values.

### PROSPECTIVE EXAMPLES 3 AND 4

### PROSPECTIVE EXAMPLE 3

### COBALT-TUNGSTEN

A layer of cobalt-tungsten is electroplated on a copper substrate for evaluation as a barrier layer. The cobalt-tungsten coating is deposited using a bath containing cobalt sulphamate, sodium tungstate, and citric acid. The pH of the plating bath is adjusted to a range of about 7-9 using ammonium hydroxide.

TABLE 6

| Example | VIII |
|---|---|
| Acid Etch | |
| Strike | |
| Anode | inert (stainless steel) or Co—W |
| Cathode | |
| Plating Bath Composition | cobalt sulphamate, sodium |
| | tungstate, citric acid |
| Plating Bath Additives | |
| Plating Bath Temperature (° F.) | 140 |
| Current Density (ASF) | 20-30 |
| Time (minutes) | 5 |
| pH range | 7-9 |
| pH adjustment | ammonium hydroxide |
| Plating Deposit | cobalt—tungsten |

### PROSPECTIVE EXAMPLE 4

### COBALT-NICKEL-TUNGSTEN

A layer of cobalt-nickel-tungsten is electroplated on a copper substrate for evaluation as a barrier layer. The cobalt-nickel-tungsten coating is deposited using a bath containing cobalt and nickel sulphamate, sodium tungstate and citric acid. The pH of the plating bath is adjusted to a range of about 7-9 using ammonium hydroxide.

TABLE 7

| Example | IX |
|---|---|
| Acid Etch | |
| Strike | |
| Anode | inert or soluble W |
| Cathode | |
| Plating Bath Composition | cobalt and nickel sulphamate, sodium |
| | tungstate and citric acid |
| Plating Bath Additives | |
| Plating Bath Temperature (° F.) | |
| Current Density (ASF) | 20-40 |
| Time (minutes) | 5 |
| pH range | 7-9 |
| pH adjustment | Ammonia |
| Plating Deposit | cobalt—nickel—tungsten |

All the coatings are expected to have low galling characteristics and, hence, low insertion force compared to only tin coated contacts.

### WORKING EXAMPLES 5A - 5C

### COMPARISON OF COBALT AND NICKEL

Examples 5A through 5C compares the contact resistance characteristics of one embodiment of the present invention utilizing cobalt as the material for the barrier coating to a nickel material as a standard nickel barrier coating.

For examples 5A-5C, the Ni barrier coating was plated from a nickel sulphamate bath with a pH of 3-3.5 at a current density of about 150 amps/ft² (“ASF”).

For examples 5A-5C, the cobalt barrier coating was plated from a cobalt sulphamate bath with a pH of 3.5, a concentration of about 100 grams of cobalt/1 liter of solution, a temperature of about 140F. and at about the same current density. Although these specific conditions were utilized for these examples, other suitable conditions that may have been utilized for these examples include: other solutions of cobalt salt; concentration ranges from about 50 to about 200 grams of cobalt/1 liter of solution; temperature ranges of about 80F. to about 200F.; additives such as wetting agents; and a ph range of about 2.5 to about 5. The pH may be adjusted to improve the ductility properties of the cobalt.

For example 5B, following the application of the barrier coating, the samples were finish coated with a 5 micro-inch of gold. For example 5C, following the application of the barrier coating, the samples were finish coated with a 40-50 micro-inch of Sn—Pb alloy. All coating thickness values were measured using an XRF technique.

For examples 5A-5C, the effectiveness of the barrier coating was evaluated by measuring the change in contact resistance values when exposed to normal application temperatures over time. The contact resistance test method utilized was ASTM B 667-92 (“Standard Practice for Construction and Use of a Probe for Measuring Electrical Contact Resistance”). In order to simulate this “aging” process, accelerated aging conditions were employed—samples were aged in air at 150F. and 250F. for various times and the contact resistance values were measured at 100 gms.

The change in contact resistance is caused by a number of interactions including: diffusion of Cu through the barrier layer and its subsequent oxidation; formation of intermetallic compounds, particularly Cu—Sn intermetallics for the Sn or Sn—Pb finish coatings; interdiffusion of the barrier and the finish coatings forming solid solutions or intermetallic compounds. A more effective barrier coating is a barrier coating that retards the interactions discussed above. Thus, a more effective barrier coating shows a smaller change in contact resistance values when exposed to normal application temperatures over time—the simulated aging process.

### WORKING EXAMPLE 5A

Copper alloy strips were coated with 15-20 micro-inch thick Ni or Co barrier coatings and samples were aged in air at 150F. for various times as shown in Table 8 below. Table 8 showed that barrier coating made by a material of cobalt of the present invention was more effective than the Ni barrier as its contact resistance changed at a slower rate than that of the Ni barrier coating.

TABLE 8

| Aging time at | 100 gm contact resistance, | | 100 gm contact resistance, | |
|---|---|---|---|---|
| 150 F., Hrs. | Ni barrier | | Co barrier | |
| 0 (as-received) | 3.8 | m.ohms | 2.67 | m.ohms |
| 168 | 12.8 | m.ohms | 5.43 | m.ohms |
| 504 | 72.4 | m.ohms | 17.4 | m.ohms |
| 1008 | 92.0 | m.ohms | 28 | m.ohms |

### WORKING EXAMPLE 5B

Following the application of 15-20 micro-inch of Ni or Co barrier coatings, the copper alloy samples were finish coated with a 5 micro- inch of Au. The samples were aged in air at 150F. for different times and their contact resistance values were measured as a function of aging time as shown in Table 9. Table 9 again showed that barrier coating made by a material of cobalt of the present invention was more effective than the Ni barrier as its contact resistance changed at a slower rate than that of the Ni barrier coating.

TABLE 9

| Aging time at | 100 gm contact resistance, | | 100 gm contact resistance, | |
|---|---|---|---|---|
| 150 F., Hrs. | Ni barrier + Au finish | | Co barrier + Au finish | |
| 0 (as-received) | 1.89 | m.ohms | 0.68 | m.ohms |
| 168 | 1.71 | m.ohms | 0.68 | m.ohms |
| 504 | 3.49 | m.ohms | 1.76 | m.ohms |
| 1008 | 5.06 | m.ohms | 1.25 | m.ohms |

### WORKING EXAMPLE 5C

Following the application of Ni and Co barrier coatings of 15-20 micro inch thick, copper alloy strips were coated with a 40-50 micro-inch thick Sn-Pb alloy finish coating. The samples were aged in air at 250F. and their 100 gm contact resistance values were measured as a function of aging time as illustrated in Table 10. Table 10 again showed that barrier coating made by a material of cobalt of the present invention was more effective than the Ni barrier as its contact resistance changed at a slower rate than that of the Ni barrier coating.

TABLE 10

| Aging time at | 100 gm contact resistance, | | 100 gm contact resistance, | |
|---|---|---|---|---|
| 250 F., Hrs. | Ni barrier + Sn—Pb finish | | Co barrier + Sn—Pb finish | |
| 0 (as-received) | 0.654 | m.ohms | 0.98 | m.ohms |
| 168 | 5.15 | m.ohms | 2.28 | m.ohms |
| 504 | 26.2 | m.ohms | 1.78 | m.ohms |
| 1008 | | | 2.36 | m.ohms |

### WORKING EXAMPLE 6

### COBALT ALLOY

A Co/Ni alloy was plated on copper strips by using a bath of 70% nickel sulphamate and 30% cobalt sulphamate. The pH of the bath was about 3.5 and the coating was electroplated at about 50 ASF. The samples were evaluated for friction coefficient, as the “insertion force” which is dependent on friction coefficient is also another criterion for barrier coating optimization. Friction tests were conducted using the following conditions: 10 cycle sliding test; normal load 67 gms; bright Tin “dimple” coupon; coated sample fastened to the sliding base; and three samples per coating.

The coatings were compared against bright Tin, 70Ni30Co, and Co. A lower friction coefficient should result in a lower insertion force for connector applications. A comparison of the friction coefficients of the three samples are shown in Table 11 below.

TABLE 11

| Coating Combination | Mean Friction Coefficient |
|---|---|
| Sn/Sn | .59 |
| 70Ni30Co/Sn | .29 |
| Co/Sn | .39 |

As shown in Table 11, a cobalt-nickel alloy had a lower friction coefficient Consequently, the above results show that, with an appropriate finish, the present invention can yield both a low friction and contact resistance.

Although particular embodiments of the invention have been described in detail for purposes of illustration, various changes and modifications may be made without departing from the scope and spirit of the invention. All combinations and permutations of the electrical contacts and operational methods are available for practice in various applications as the need arises. Any substrate material other than copper may be used. Accordingly, the invention is not to be limited except as by the appended claims.

What is claimed is:

1. A metal contact for a copper alloy surface, comprising:
an electroplated barrier layer having a thickness ranging from about 0.00001 inch to about 0.0001 inch, wherein the barrier layer is selected from the group consisting of cobalt, cobalt-nickel alloys, cobalt-tungsten alloys, cobalt-nickel-tungsten alloys, and rhodium.

2. The metal contact of claim 1, wherein the barrier layer thickness is 0.000025 to 0.0001 inch.

3. The metal contact layer of claim 2, wherein the barrier layer is cobalt.

4. The metal contact of claim 2, wherein the barrier layer is a cobalt-nickel alloy.

5. The metal contact of claim 2, wherein the barrier layer is a cobalt-tungsten alloy.

6. The metal contact of claim 2, wherein the barrier layer is a cobalt-nickel-tungsten alloy.

7. The metal contact of claim 1, further comprising an outer layer.

8. A method of forming a metal contact having a barrier layer ranging from about 0.00001 inch to about 0.0001 inch, comprising the steps of:
providing a substrate; and
electroplating a barrier layer on the substrate, wherein the barrier layer is selected from the group consisting of cobalt, cobalt-nickel alloys, cobalt-tungsten alloys, cobalt-nickel-tungsten alloys, and rhodium.

9. The method of claim 8, further comprising the step of performing a light acid etch before the step of electroplating.

10. The method of claim 9, further comprising the step of activating the surface before the step of electroplating.

11. The method of claim 8, wherein the cobalt is electroplated at a current density of about 10-150 amperes per square foot.

12. The method of claim 11, wherein the plating bath includes a cobalt sulphamate, cobalt sulfate, and/or cobalt chloride.

13. The method of claim 12, wherein the plating bath further includes tungsten salt, organic acid, and ammonium oxide.

14. The method of claim 13, wherein the tungsten salt is sodium tungstate.

15. The method of claim 14, wherein the organic acid is citric acid.

16. The method of claim 12, wherein the plating bath further includes nickel sulfamate, nickel sulfate, and/or nickel chloride and organic additives.

17. The method of claim 8, wherein in the substrate is copper.

18. The method of claim 8, further comprising the step of providing an outer layer in contact with the barrier layer.

19. The method of claim 17, wherein the outer layer is selected from the group consisting of tin, gold, palladium, platinum, silver, and combinations thereof.

20. The method of claim 19, wherein the outer layer is tin.

21. The electrical contact of claim 8, wherein the outer layer is selected from the group consisting of tin, gold, silver, platinum, palladium and combinations thereof.
